(19) United States
(12) Patent Application Publication
(10) Pub. No.: US 2013/0326838 A1
(43) Pub. Date: Dec. 12, 2013

(54) WIPER BLADE FOR CLEANING PANES, IN PARTICULAR OF MOTOR VEHICLES

(71) Applicants: Raf Greunlinx, Heusden-Zolder (BE); Jochen Weidlich, Rastatt (DE)

(72) Inventors: Raf Greunlinx, Heusden-Zolder (BE); Jochen Weidlich, Rastatt (DE)

(73) Assignee: ROBERT BOSCH GMBH, Stuttgart (DE)

(21) Appl. No.: 14/001,598

(22) PCT Filed: Feb. 16, 2012
(86) PCT No.: PCT/EP2012/052704

§ 371 Date: Aug. 26, 2013

(30) Foreign Application Priority Data
Feb. 24, 2011 (DE) 102011004629.1

(51) Int. Cl. B60S 1/38

(52) U.S. Cl. CPC B60S 1/38
USPC 15/250.48; 29/428

(57) ABSTRACT

The invention relates to a wiper blade (10) and to a method for producing a wiper blade (10) for wiping panes, in particular motor vehicle panes, comprising a support element (12) for receiving a wiper strip (14), to which a connecting device (20) is attached, which has a wiper blade-side part (15) having claw-like receptacles (34, 36) surrounding the support element (12) at least in some regions. According to the invention, the connecting device comprises passages and/or openings which allow a weld connection or can receive melt flow.

### BACKGROUND OF THE INVENTION

In wiper blades for wiping panes, comprising a support element for receiving a wiper strip, to which a connecting device is fastened, said connecting device having a part on a wiper blade side with claw-like receivers, which at least partially encompass the support element, the support element is intended to ensure a distribution which is as uniform as possible of the contact pressure of the wiper blade on the pane, originating from the wiper arm, over the entire wiping area covered by the wiper blade. By means of an appropriate curvature of the unloaded support element—i.e. when the wiper blade does not bear against the pane—the ends of the wiper strip, which is applied fully against the pane during operation of the wiper blade, are urged toward the pane by the support element which is then tensioned, even if the radii of curvature of spherically curved vehicle windshields change in every wiper blade position. The curvature of the wiper blade thus has to be somewhat greater than the greatest curvature measured in the wiping area on the pane to be wiped. A connecting device is fastened to the support element via which the connection to the wiper arm is produced.

It has been disclosed in EP 0914269 B1 to fasten the connecting device to the support element by means of a weld connection. To this end, the connecting element on the wiper blade side, which consists either of metal or a plastics material, is applied or pushed onto the support element and connected by a material connection to the support element, by means of resistance welding in the case of a metal connecting element or by means of ultrasonic welding in the case of a plastics connecting element. This weld connection is subjected to extreme conditions in everyday use and has to withstand high torques and vibrations, additionally in variable weather conditions. In particular, in wiper blades produced in large quantities, the weld connection sets high requirements in terms of the quality of the process management.

### SUMMARY OF THE INVENTION

A wiper blade according to the invention has the advantage that the welding may be carried out at defined points in predefined conditions.

By means of the through-passages and/or recesses, it is possible to introduce the energy in a targeted manner and to control the melt flow. As a result, it is possible to increase or even to limit the welding zone to predetermined regions so that the strength and resilience between the connecting device and the support element are able to have predetermined values.

In order to control the melt flow further, it is expedient to arrange the through-passages and/or recesses opposite an upper convex face of the support element or opposite a lower concave face of the support element. It may also be expedient if the corresponding through-passages have a different size on the side opposite the through-passages on the other side and/or are arranged offset relative to one another.

The invention also relates to a method for producing a wiper blade in which the energy is introduced via the through-passages according to the invention provided in the connecting device and the connecting device is connected in this manner to the support element. By means of the through-passages and/or recesses it is possible to introduce the energy in a targeted manner and to control the melt flow. As a result, it is possible to increase or even to limit the welding zone to predetermined regions so that the strength and resilience between the connecting device and the support element are able to have predetermined values.

The energy may be introduced in a particularly simple manner by means of ultrasonic sonotrodes.

The introduction of energy may take place in a particularly controlled manner if a plurality of sonotrodes are used, said sonotrodes introducing energy via through-passages of both the upper face and the lower face. The sonotrodes may advantageously be of variable diameter, for example the sonotrodes which protrude through the upper through-passages may be of greater diameter than those which protrude through the lower through-passages. In this manner, both the introduction of energy and the pressure to be applied by the sonotrodes onto the connecting device and/or the support element may be individually optimized.

For further optimization of the melt flow, the sonotrodes are preferably placed on opposing sides on the connecting device and/or on the support element, wherein opposing sonotrodes are arranged offset relative to one another. The melt flows are thus produced at different points from one another and preferably move toward one another in each case on the side thereof facing the support element. As a result, it is possible to control the melt flow so that it does not flow excessively over the edges of the support element and/or the connecting device.

If recesses are provided in the connecting device on the sides opposing the sonotrodes, here the activation of the melt flow is delayed. If the recesses are offset relative to the sonotrodes, the melt flow is still produced but limited in the direction of the recesses.

The welding process may be controlled if an auxiliary body is introduced between the upper face of the support element and the connecting device. Said auxiliary body is removed again after the welding has taken place. Said auxiliary body may consist of different metals, plastics material or ceramics, depending on the extent to which the welding process is intended to be controlled.

If the auxiliary body is configured as a heat sink which is thus able to absorb heat from the support element, in particular, the melt flow is restricted as a result.

By introducing an auxiliary body which preferably acts on the support element, the support element may be loaded such that it is forced from its curved position in the unloaded state into an entirely or partially extended position. The support element is thus moved into an extended position as predetermined during normal operation on the vehicle windshield by the loading of the wiper arm. The weld connection is thus carried out so that in the operating position it remains more or less without tension.

The invention also relates to a method for producing a wiper blade, in which the support element with an auxiliary body below the connecting device or bearing against the connecting device is preferably moved into a substantially extended position and energy is introduced to connect the connecting device to the support element, said energy connecting the connecting device to the support element by a positive and/or material connection. In this manner, only the support element is loaded whilst the connecting device is able to be accurately positioned. The auxiliary body is introduced immediately before introducing the energy and removed again after the connection is complete. During the connection process, the auxiliary body is able to absorb excess energy and thus control the connecting sequence.

If the support element has a slot, the auxiliary body may be simply pushed along the support element from the outside and after the connection process pulled out again.

The auxiliary body may be advantageously configured in a T-shape, wherein the width of the T-bar is slightly narrower than the width of the slot in the support element, so that the T-bar is inserted from below into the slot and is then able to be twisted until it overlaps the support element. The support element is then moved into an approximately extended position and energy introduced for fastening the connecting device. Subsequently, the support element is unloaded again and the auxiliary body twisted back and removed.

If the T-limb of the auxiliary body is not round and configured so that when twisted it moves the slot to a predetermined distance and/or holds the slot at a predetermined distance, a dimensional stability may be ensured in a simple manner. It is also possible, however, to introduce a support element, which consists of two longitudinal rails, in a defined manner into receiving regions of the connecting device.

### BRIEF DESCRIPTION OF THE DRAWINGS

In the drawings:

FIG. 1 shows a wiper blade according to the invention in a perspective view with the wiper arm indicated in dashed-dotted lines and the surface of a windshield indicated in dashed-dotted lines,

FIG. 2 shows a view along II-II in FIG. 1,

FIG. 3 shows a schematic view of the view according to FIG. 2 with only one spring rail,

FIG. 4 shows a schematic view in the viewing direction IV in FIG. 1 with only one end cap,

FIG. 5 shows a sectional view of a connecting device with the sonotrodes introduced,

FIG. 6 shows a sectional view of a connecting device with the sonotrodes introduced and an auxiliary body,

FIGS. 7 to 11 show schematic views of the connecting device similar to FIG. 5 with variable arrangements of sonotrodes, recesses and auxiliary bodies and FIGS. 12 and 13 show variable auxiliary bodies.

### DETAILED DESCRIPTION

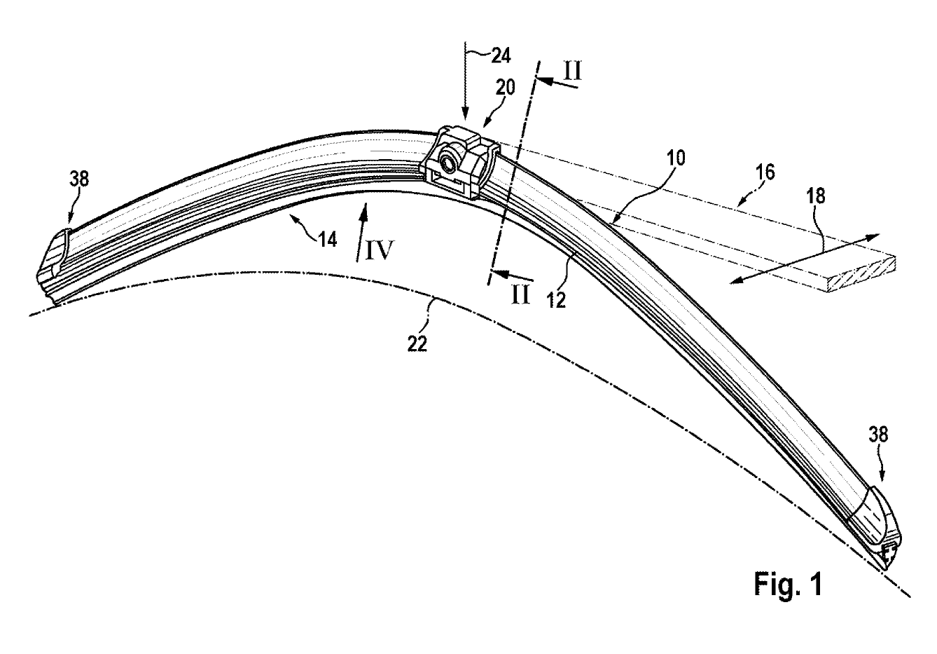

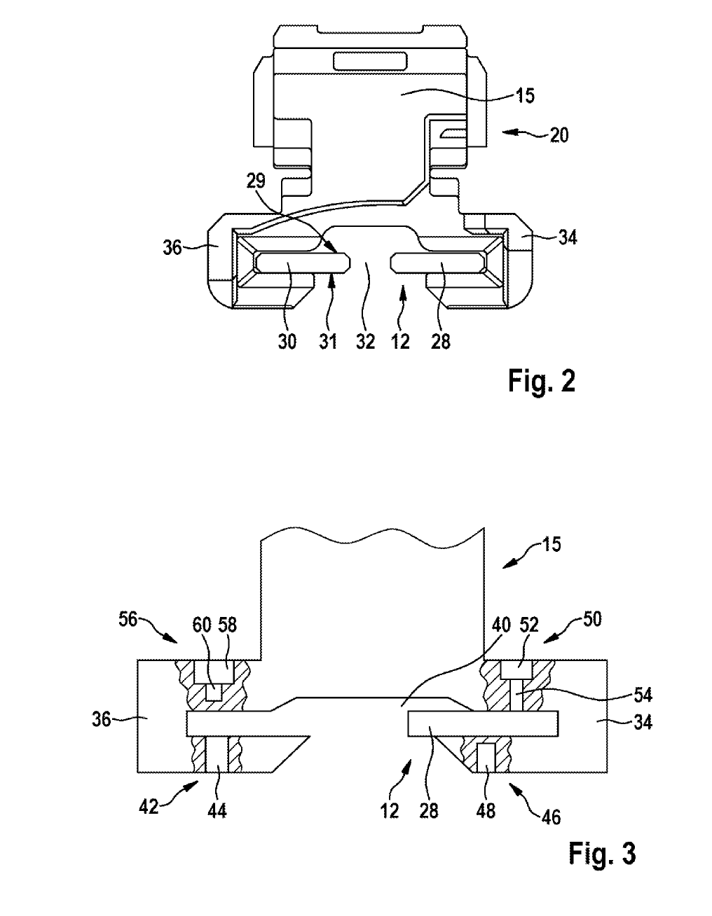

A wiper blade 10 shown in FIG. 1 has a strip-like, elongated, rubber-elastic support element 12 (FIGS. 1 and 2), on the lower strip side 13 thereof facing the pane, an elongated rubber-elastic wiper strip 14 being fastened parallel to the longitudinal axis. The part 15 of a connecting device on the wiper blade side is arranged on the upper strip side 11 of the support element 12, also to be denoted as a spring rail, remote from the pane, in the central portion thereof, by means of which the wiper blade 10 is able to be releasably connected in an articulated manner to a wiper arm 16 indicated in dashed-dotted lines in FIG. 1. The wiper arm 16, driven in an oscillating manner in the direction of a double arrow 18 in FIG. 1, is loaded in the direction of an arrow 24 relative to the pane to be wiped, for example relative to the windshield of a motor vehicle—the surface thereof in FIG. 1 being indicated by a dashed-dotted line 22. As the line 22 is intended to represent the greatest curvature of the pane surface, it is clearly visible that the curvature of the wiper blade which bears against the pane with both ends thereof, and is still unloaded, is greater than the maximum pane curvature (FIG. 1). Under the contact pressure (arrow 24) the wiper blade 10 bears with its wiper lip 26 over its entire length against the pane surface 22. In this case, in the spring-elastic support element 12 produced from metal, a tension is created which ensures correct bearing of the wiper strip 14 and/or the wiper lip 26 over the entire length thereof against the pane surface 22 and also for the uniform distribution of the contact pressure (arrow 24).

Further details of the specific embodiment of the wiper blade according to the invention are to be provided below.

In FIG. 2 it may be seen that the support element 12 is made up of two spring strips 28 and 30 separated from one another, which are spaced apart from one another and form a gap 32. The connecting device 15 has in a lower region two U-shaped receivers 34 and 36, in which the spring strips 28 and 30 are received. The receivers 34 and 36 encompass the spring strips 28 and 30 in each case over a greater part of their cross section, wherein the part of the connecting device 15 corresponding to the wiper arm 16 is arranged on the convex face 29 of the support element 12, whilst the concave face 31 opposes said convex face.

In FIG. 3, the connecting device 15 is shown schematically, wherein the corresponding spring strip 28 is illustrated in the receiver 34 whilst the spring strip 30 is not located in the corresponding receiver 36. It may be seen that the receivers 34 and 36 encompass the spring strips 28 and 30 with a snug fit. In the region above the spring strips 28 and 30, and above the gap 32, the connecting device 15 has a recess 40 into which a top part of a wiper strip comes to rest when the wiper blade 10 is assembled.

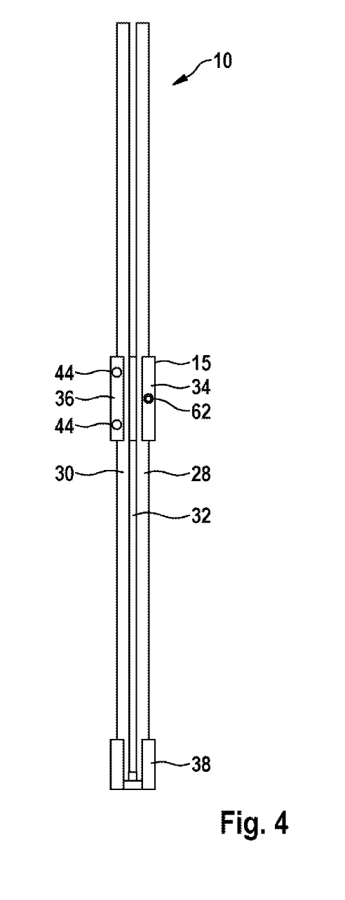

The wiper blade 10 which is shown in FIG. 4 from below and which is illustrated without the wiper strip 14 and/or the wiper lip 26, reveals the spring strips 28 and 30, the gap 32 as well as the receivers 34 and 36 of the connecting device 15. In this embodiment of the wiper blade 10, it may be seen that the spring strips 28 and 30 are entirely separate from one another and merely held together by the connecting device 15 and/or via end caps 38, only one thereof being shown at one end in FIG. 4.

The wiper blade 10 according to the invention is characterized in that the connecting device comprises through-passages and/or recesses which allow a weld connection or are also able to receive melt flow. In FIG. 3, various through-passages and recesses for introducing energy are shown, wherein it is clear that the person skilled in the art will accordingly select the respective embodiment to optimize the connection thereof and the process reliability. In the region 42, a simple through-hole 44 is shown, through which a sonotrode is directly placed onto the spring strip and heating, originating from the support element, is able to take place. In the region 46, a blind hole 48 is shown in which the sonotrode initially melts and penetrates a part of the material of the connecting device 15 before contact is made with the spring strip 28. In the region 50, a two-step through-hole is shown with a first larger blind hole 52 and a smaller through-hole 54 adjacent thereto. In the region 56, a two-step blind hole is shown with a larger first blind hole 58 and a second smaller blind hole 60 adjacent thereto. It may be observed that the opposing through-passages and/or recesses do not have to be of the same size or of the same shape, but naturally they can be. Moreover, the through-passages and/or recesses may directly oppose one another or may be more or less offset relative to one another. Such an offset may be provided both in the transverse direction and in the longitudinal direction of an individual spring rail 28 or 30.

In FIG. 4, through-holes 44 which are incorporated in the receiver 36 may be seen from below. A single through-hole 62, similar to the through-hole shown in the region 50, is incorporated in the receiver 34.

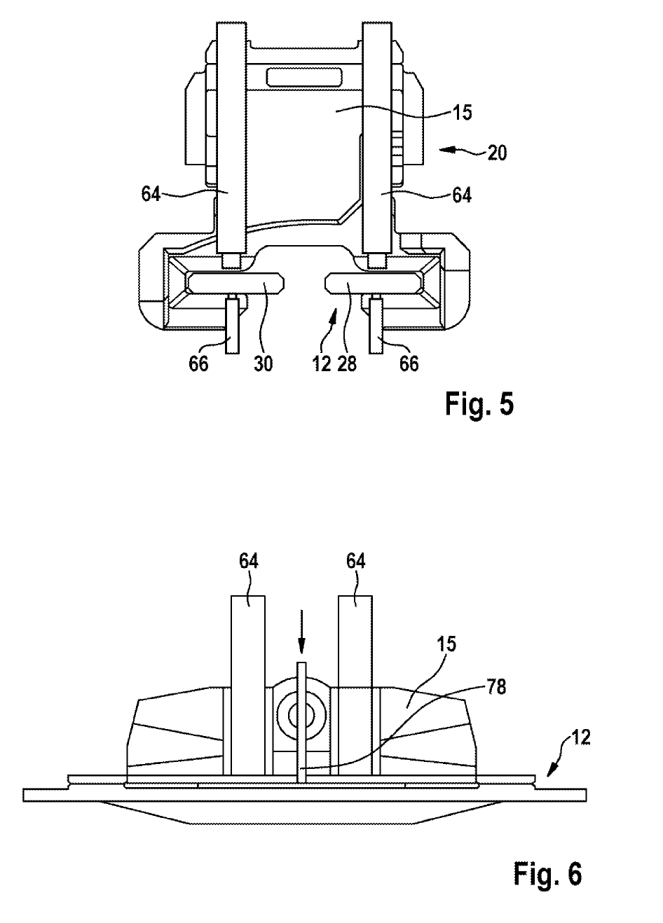

The connection between the connecting elements 15 and the spring strips 28 and 30 of the support element 12 takes place by the addition of energy, in which generally the material of the connecting device 15 is melted and connected by a positive and/or by a material connection to the material of the support element 12. To this end, the connecting device 15 consists at least partially of plastics material whilst the spring rails 28 and 30 of the support element 12 generally consist of spring steel encased in plastics material. It is, however, also conceivable to use spring rails 28 and 30 consisting only of metal or only of plastics material. The energy is supplied, as shown in FIG. 5, by means of upper sonotrodes 64 and lower sonotrodes 66. In FIG. 6 it is shown that the sonotrodes are also able to act merely from one side.

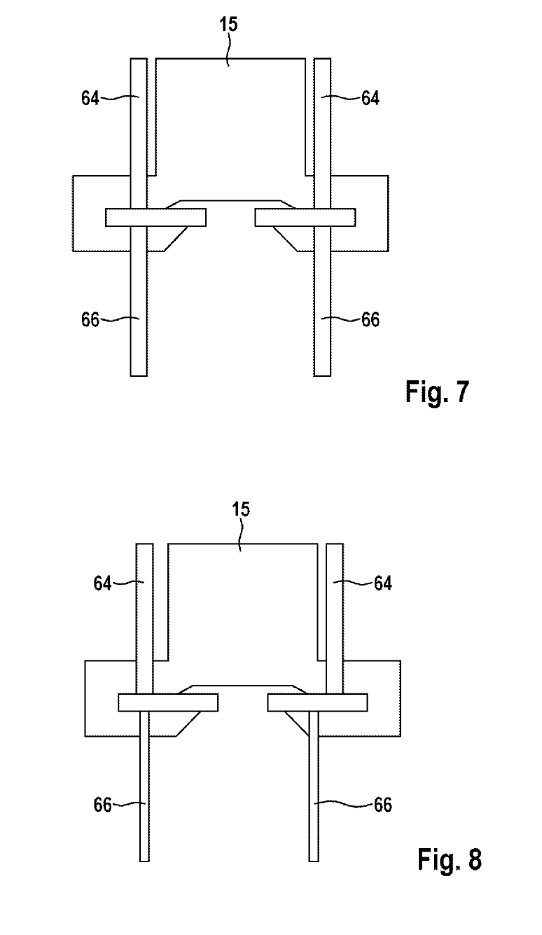

In FIGS. 7 to 10, it is shown thematically that the upper sonotrodes 64 are of the same size as the lower sonotrodes 66 and oppose said sonotrodes. In FIG. 8, the sonotrodes 64 are larger in diameter than the sonotrodes 66. On the left-hand side, the sonotrodes are located directly opposite one another whilst on the right-hand side the upper sonotrode 64 and the lower sonotrode 66 are arranged offset relative to one another. In FIG. 10, in each case only one upper and/or one lower sonotrode 64 and/or 66 is shown, wherein a recess 68 directly opposes the upper sonotrode 64, whilst a recess 70 opposes the lower sonotrode 66 in an offset manner. Also in this case, said arrangement is only shown by way of example and it is clear to the person skilled in the art that is it possible to arrange the recesses 68 and/or 70 at the top or bottom and/or directly opposing or offset therefrom, depending on the other process parameters in order to optimize the process thereby.

In the method according to the invention for producing a wiper blade 10 comprising a support element 12 for receiving a wiper strip 14, to which a connecting device 15 is fastened, said connecting device having claw-like receivers 34, 36, which at least partially encompass the support element 12, the energy is introduced via the through-passages 44, 54, 62 or recesses such as the blind hole 48, 52, 58 or 60 and the connecting device 15 is connected to the support element 12.

The energy is preferably introduced as ultrasonic energy by means of ultrasonic sonotrodes 64, 68.

Preferably a plurality of sonotrodes 64, 68 are used. Said sonotrodes are used at the same time or staggered chronologically. Moreover, said sonotrodes are able to introduce the energy from the upper and/or the lower face. Preferably, the sonotrodes 64 of the upper face are configured to be larger than the sonotrodes 66 of the lower face.

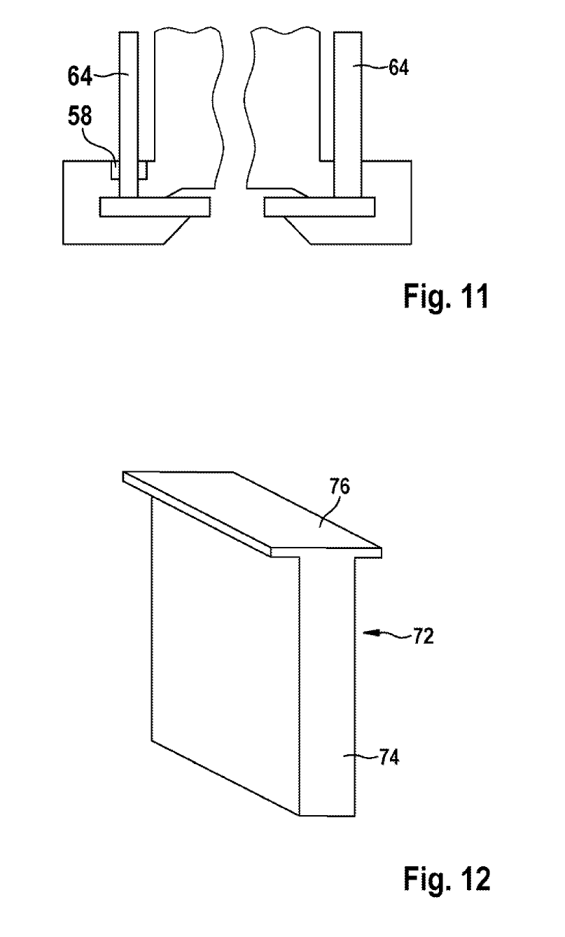

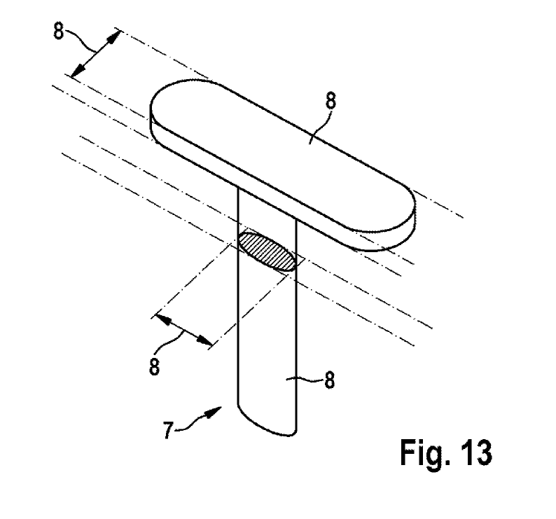

According to a further embodiment of the method according to the invention, as shown in FIG. 11, initially the energy is introduced by a smaller upper sonotrode 64 (left-hand side) and then the connection is completed by a larger sonotrode 64 (right-hand side). This method is naturally also implemented from the lower face. By melting the additional material, hollow spaces which are provided for tolerance reasons, for example, may be filled up.

In a further embodiment of the method according to the invention, the sonotrodes on opposing sides are placed on the connecting device 15 and/or on the support element 12, wherein the opposing sonotrodes 64, 66 are offset relative to one another. As visible in FIG. 10, recesses 68 and/or 70 are arranged in the regions opposite the sonotrodes 64 and/or 66. The recess 68 opposes the sonotrode 64 directly so that the energy introduced by the sonotrode 64 is not able to melt the material of the receiver 36 on the directly opposing side. Instead a melt flow is produced which moves toward the recess 68. On the right-hand side of FIG. 10 it is shown that the recess 70 may be arranged offset to the opposing sonotrode 66. The energy introduced by the sonotrode 66 is able to melt the material of the connecting device 15 in the opposing region, so that a melt flow is produced away from this point in the direction of the recess 70 and/or the recess 40.

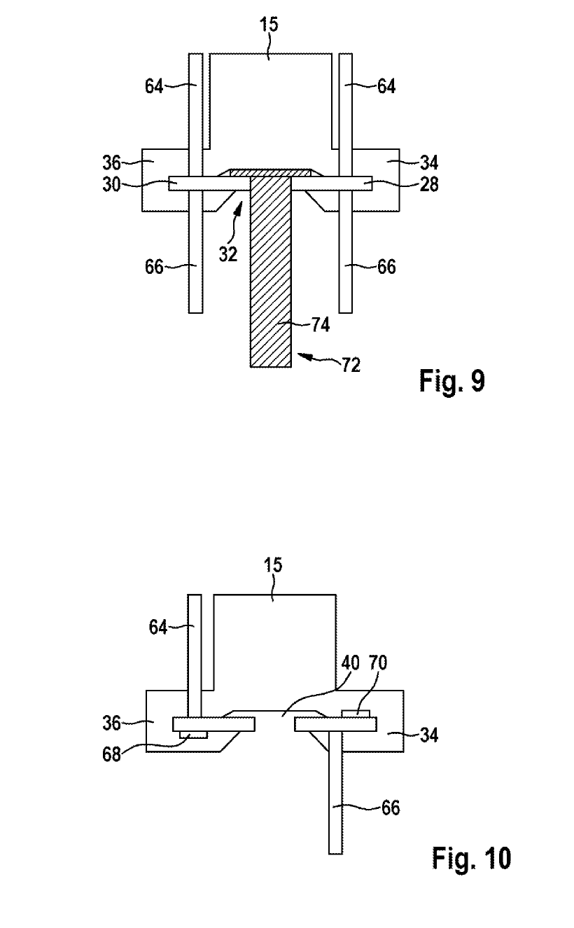

As shown in FIG. 9, the spring strips 28 and 30 are spaced apart by an auxiliary body 72. The auxiliary body 72 is of T-shaped configuration, wherein the T-limb 74 has a width which corresponds to the width of the gap 32 and the T-bar 76 partially overlaps the spring strips 28 and 30. To this end, the T-bar 76 is located within the recess 40.

The auxiliary body 72 firstly acts in a stabilizing manner, by pressing the spring strips 28 and 30 into the receivers 34 and 36 and is fixed there until the welding process is complete and the plastics material has cured again. Secondly, the auxiliary body 72 acts to equalize the temperature as, acting as a heat sink, it is able to absorb excess energy which would have the effect of increasing the temperature in the spring strips 28 and 30 in the direction of the gap 32. As a result, a potential melt flow in the direction of the gap 32, originating from the sonotrodes 64 and 66 and the energy introduced there, is reduced and/or stopped.

The method according to the invention for producing a wiper blade 10 comprising a support element 12 for receiving a wiper strip 14, to which a connecting device 20 is fastened, said connecting device having a part 15 on the wiper blade side with claw-like receivers 34 and 36, which at least partially encompass the support element 12, is also characterized in that by means of the auxiliary body 72 below the connecting device 20 or adjacent to the connecting device 20, the support element 12 is moved into a substantially extended position and energy is introduced for connecting the connecting device 20 to the support element 12, said energy connecting the connecting device 20 to the support element 12 by a positive and/or material connection.

To this end, the support element 12 has a gap 32 in which the auxiliary body 72 is pushed from outside along the support element 12 and, after the connection is made, is pulled out again. The auxiliary body 72 may naturally also be introduced into the gap 32 by the wiper blade 10 and/or the support element 12, with the connecting device 20 already pushed on, being moved relative to the auxiliary body 72 whilst the auxiliary body 72 remains stationary. If the auxiliary body 72 is in position, together with the receivers 34 and 36 it fixes the spring strips 28 and 30 in position so that the welding process is able to take place securely.

The auxiliary body 72, as FIG. 12 shows, may be of cuboidal shape, with a first cuboid as the T-limb 74 and a second cuboid as the T-bar 76. The fastening in a machine is therefore carried out via the lower region of the T-limb 74, which is either simply clamped or to this end may also comprise corresponding receivers, not shown.

It is, however, also possible to create an auxiliary body 78 from oval-shaped portions, with an elliptical T-limb 80 and a similarly elliptical T-bar 82. The width 84 of the T-bar 82 is slightly less than the width of the gap 32, so that the auxiliary body 78 is able to be introduced from below into the gap 32. The auxiliary body 78 is then twisted by ca. 90°, so that the T-bar 82 overlaps the spring strips 28 and 30. The support element 12 is thus able to be pulled into an extended position. After connecting the connecting device 20 to the support element 12, the support element 12 is unloaded again, the auxiliary body is rotated by ca. 90° and removed from the gap 32.

The T-limb 80 is also elliptical, wherein the large main axis of the ellipse has a length 86 which corresponds to the size of the gap 32. As a result, when the auxiliary body 78 is twisted, the spring strips 28 and 30 are pressed into the receivers 34 and 36 and held until the connecting device 20 and the support element 12 are connected together. If the auxiliary body 78 is then rotated back, the spring strips 28 and 30 remain in the preset position.

As visible in FIG. 6, the auxiliary body 78 may also be introduced from the top through the part 15 of the connecting device 20 on the wiper blade side, provided the required through-passage is present.

It is clear to the person skilled in the art that the embodiments of the auxiliary bodies 72 and/or 78 may be combined with the different embodiments of the corresponding through-passages and/or recesses. In cooperation with the recesses 68 and 70 shown in the example in FIG. 10, by the specific removal of the heat via the auxiliary body, the melt flow may be influenced in flow velocity, flow direction and flow duration. Naturally, it is also possible to introduce heat via the auxiliary body 72 and/or 78 into the connecting zones. The correct choice of size and arrangement of the through-passages and recesses and the auxiliary body is highly dependent on the materials of the connecting device and the spring strips used. The person skilled in the art may select these by a series of tests so that the process is optimized and the quality improved thereby.

1. A wiper blade for wiping panes, comprising a support element (12) for receiving a wiper strip (14), to which a connecting device (20) is fastened, said connecting device having a part (15) on a wiper blade side with claw-like receivers (34, 36), which at least partially encompass the support element (12), characterized in that the connecting device (20) comprises at least one of through-passages (44, 52, 54) and recesses (48, 58, 60, 68, 70), which allow a weld connection or are also able to receive melt flow.

2. The wiper blade as claimed in claim 1, characterized in that the through-passages (44, 52, 54) or recesses (48, 58, 60, 68, 70) are arranged opposite an upper convex face (29) of the support element (12) or opposite a lower concave face (31) of the support element (12).

3. The wiper blade as claimed in claim 1, characterized in that the through-passage or the through-passages (44, 52, 54) on the upper face (99) have a different size from those on the lower face (31).

4. The wiper blade as claimed in claim 1, characterized in that the through-passage or the through-passages (44, 52, 54) on the upper face (29) are arranged offset relative to those on the lower face (31).

5. A method for producing a wiper blade (10) comprising a support element (12) for receiving a wiper strip (14), to which a connecting device (20) is fastened, said connecting device having a part (15) on the wiper blade side with claw-like receivers (34, 36), which at least partially encompass the support element (12), as claimed in claim 1, characterized in that energy is introduced via the through-passages (44, 52, 54) or recesses (48, 58, 60) in the connecting device (20), which connects the connecting device (20) to the support element (12).

6. The method as claimed in claim 5, characterized in that the energy is introduced into the support element by means of ultrasonic sonotrodes (64, 66).

7. The method as claimed in claim 6, characterized in that a plurality of sonotrodes (64, 66) is used, said sonotrodes introducing energy both via through-passages (44, 52, 54) of an upper face (29) and a lower face (31).

8. The method as claimed in claim 6, characterized in that when the energy is supplied, sonotrodes (64) of greater diameter protrude through upper through-passages (52, 54) than through lower through-passages (44).

9. The method as claimed in claim 6, characterized in that the sonotrodes (64, 66) are placed on at least one of opposing sides on the connecting device (20) the support element (12) and opposing sonotrodes (64, 66) are offset relative to one another.

10. The method as claimed in claim 6, characterized in that recesses (68) oppose the sonotrodes (64).

11. The method as claimed in claim 10, characterized in that the recesses (70) are offset relative to the sonotrodes (66).

12. The method as claimed in claim 5, characterized in that during the connection process, an auxiliary body (72, 78) is introduced between an upper face (29) of the support element (12) and the connecting device (20).

13. The method as claimed in claim 12, characterized in that the auxiliary body (72, 78) is configured as a heat sink and restricts the melt flow.

14. The method as claimed in claim 12, characterized in that the auxiliary body (72, 78) during the connection process loads the support element (12) such that the support element is forced from a curved position in the unloaded state into an entirely or partially extended position.

15. A method for producing a wiper blade (10) comprising a support element (12) for receiving a wiper strip (14), to which a connecting device (20) is fastened, said connecting device having a part (15) on a wiper blade side with claw-like receivers (34, 36), which at least partially encompass the support element (12), as claimed in claim 1, characterized in that by means of an auxiliary body (72, 78) below the connecting device (20) or adjacent to the connecting device (20), the support element (12) is moved into a substantially extended position and energy is introduced for connecting the connecting device (20) to the support element (12), said energy connecting the connecting device (20) to the support element (12) by at least one of a positive and a material connection.

16. The method as claimed in claim 15, characterized in that the support element (12) has a gap (32) in the form of a slot in which the auxiliary body (72, 78) is pushed along the support element from an outside and after the connection process is pulled out again.

17. The method as claimed in claim 15, wherein the support element has a gap (32) and the auxiliary body (78) is of T-shaped configuration and wherein a width of the T-bar is slightly narrower than the width of the gap (32), characterized in that the T-bar is inserted from below into the gap (32) and then twisted until the T-bar overlaps the support element (12), in that the support element (12) is then moved into an approximately extended position, in that energy is introduced for fastening the connecting device (20) and in that the support element (12) is then unloaded and the auxiliary body (78) is twisted again and removed.

18. The method as claimed in claim 17, characterized in that a T-limb of the auxiliary body (78) is not round and when twisted moves the gap (32) to a predetermined distance or holds said gap at a predetermined distance.
